(19) United States
(12) Patent Application Publication
(10) Pub. No.: US 2007/0285516 A1
(43) Pub. Date: Dec. 13, 2007

(54) METHOD AND APPARATUS FOR AUTOMATICALLY DIRECTING THE ADJUSTMENT OF HOME THEATER DISPLAY SETTINGS

(76) Inventors: MICHAEL H. BRILL, Kingston, NJ (US); Colman F. Shannon, Lawrenceville, NJ (US); Mark Hunter, Cary, NC (US); Heath Barber, Fuquay Varina, NC (US)

Correspondence Address: Patterson & Sheridan, LLP, Suite 100, 595 Shrewsbury Avenue, Shrewsbury, NJ, 07702, US

(21) Appl. No.: 11/760,598

(22) Filed: Jun. 8, 2007

Related U.S. Application Data
(60) Provisional application No. 60/812,552, filed on Jun. 9, 2006.

(51) Int. Cl. G06F 17/00

(52) U.S. Cl. 348/189; 700/90; 348/739

(57) ABSTRACT

In one embodiment, present invention is a method and apparatus for automatically adjusting home theater display settings. One embodiment of a method for adjusting a setting of a home theater display includes receiving at least one measurement of the setting from a user and directing the user to adjust the setting in response to the received measurement(s), where the degree of the adjustment is determined in accordance with a perceptual scale.

### CROSS REFERENCE TO RELATED APPLICATIONS

This application claims the benefit of U.S. Provisional Patent Application Ser. No. 60/812,552, filed Jun. 9, 2006, which is herein incorporated by reference in its entirety.

### BACKGROUND OF THE DISCLOSURE

The invention relates to the automated adjustment of home theater display settings, namely, “color temperature,” “brightness”, “contrast”, “color”, and “tint” of a home theater display.

### SUMMARY OF THE INVENTION

In one embodiment, present invention is a method and apparatus for automatically adjusting home theater display settings. One embodiment of a method for adjusting a setting of a home theater display includes receiving at least one measurement of the setting from a user and directing the user to adjust the setting in response to the received measurement(s), where the degree of the adjustment is determined in accordance with a perceptual scale.

### BRIEF DESCRIPTION OF THE DRAWINGS

The teachings of the present invention can be readily understood by considering the following detailed description in conjunction with the accompanying drawings, in which:

FIG. 1 is a flow diagram illustrating one embodiment of a method for automatically directing the adjustment of the “brightness” setting (black level) of a home theater display, according to the present invention;

FIG. 2 is a flow diagram illustrating one embodiment of a method for automatically directing the adjustment of the “contrast” (white level) setting of a home theater display, according to the present invention;

FIG. 3 is a flow diagram illustrating one embodiment of a method for automatically directing the adjustment of the “color” settings of a home theater display, according to the present invention;

FIG. 4 is a flow diagram illustrating one embodiment of a method for automatically directing the adjustment of the “tint” settings of a home theater display, according to the present invention; and

FIG. 5 is a high level block diagram of the home theater display adjustment method that is implemented using a general-purpose computing device.

To facilitate understanding, identical reference numerals have been used, where possible, to designate identical elements that are common to the figures.

### DETAILED DESCRIPTION

In one embodiment the present invention is a method and apparatus for automatically directing the adjustment of home theater display settings in substantially real time. Embodiments of a measurement and computation system according to the invention use a perceptual scale to guide a user in adjusting the home theater display settings. In the cases of “brightness” and “contrast”, the perceptual scale is luminance linearized in units of just-noticeable differences (JNDs). In the cases of “color” and “tint”, the perceptual scale is luminance in any scale, where the spectral sensitivity is simulated in a multi-filter calorimeter to approximate the International Commission on Illumination (CIE) luminance spectral sensitivity times the transmittance of a blue filter. Luminance can be assessed in any scale for “color” and “tint”, because the user is asked to balance the luminance of two colors, and any scale (monotonic function of luminance) can be used to effect this equality. In the case of “brightness” and “contrast”, the luminance scale matters because the user is asked to pronounce a difference rather than an equality.

More specifically, embodiments of the invention, when used in conjunction with a calorimeter, store calibration coefficients that enable a calibrator to guide a user in optimally adjusting five settings on a home-theater display (e.g., a television, a computer monitor or the like): “color temperature”, “brightness”, “contrast”, “color”, and “tint”. In one embodiment, the “color-temperature” adjustment involves measuring several settings with the calorimeter, and then choosing the setting that measures closest to the D65 standard illuminant (or white point) defined by the CIE. In further embodiments, adjustment of other settings involves more algorithmic subtlety.

In one embodiment, the methods according to the present invention assume the following:
(1) When increasing the “brightness” setting appreciably increases the black luminance, digital near-blacks will begin to depart perceptibly from digital black; and
(2) When decreasing the “contrast” setting appreciably decreases the white luminance, digital near-whites will begin to depart perceptibly from digital white.

### Although these assumptions are nontrivial, they have been successful and avoid interpretation of the “brightness” or “contrast” as any more than an ordinal setting.

By binary search, the “brightness” setting b is chosen in one embodiment so that black luminance at b is approximately 0.9 just-noticeable differences (JND) greater than black luminance at the minimum “brightness” setting. Similar search ensures that white luminance at the chosen “contrast” setting c is in one embodiment approximately 6 JNDs less than the white luminance at the maximum “contrast” setting. One embodiment of the method 100 uses a mapping between luminance and number of JNDs, as described in further detail below.

One method for directing the adjustment of the “brightness” setting of a home theater according to the present invention uses the function j(L), i.e., the Digital Imaging and Communications in Medicine (DICOM) number of just-noticeable differences (JNDs) as a function of luminance (cd/m²). This function is defined in further detail below.

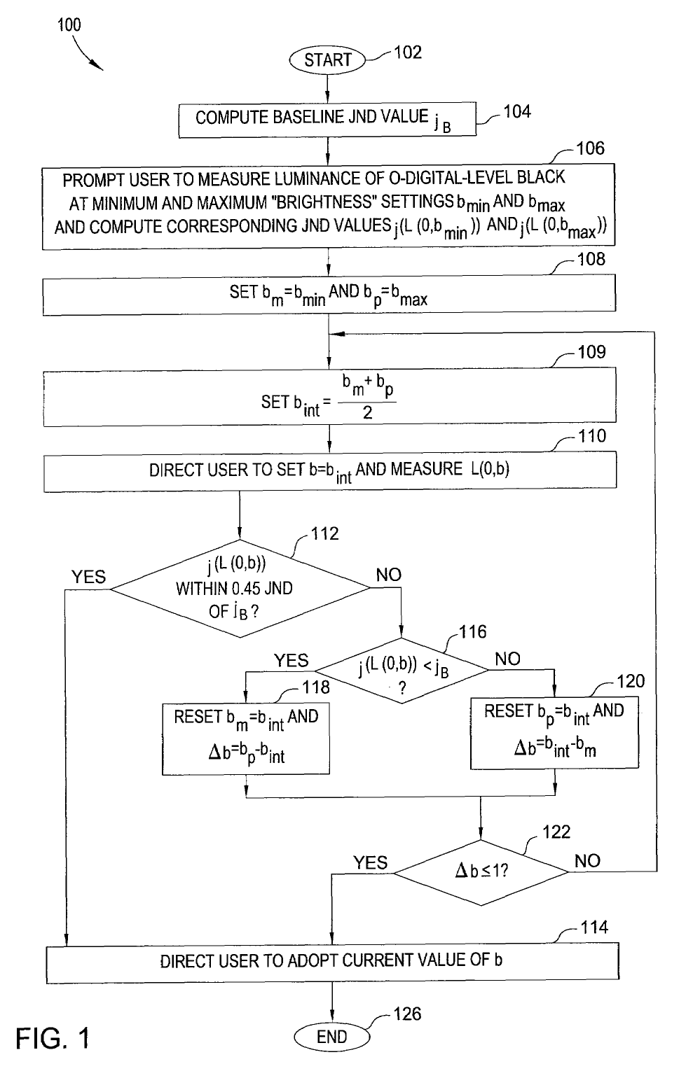

FIG. 1 is a flow diagram illustrating one embodiment of a method 100 for automatically directing the adjustment of the “brightness” setting of a home theater display, according to the present invention. The method 100 thus may be implemented, for example, in an automated, stand-alone display calibrator that operates in conjunction with a calorimeter to guide a user in the adjustment of the “brightness” setting. For the “brightness” setting b (and black), let L(0,b)=the luminance of 0-digital-level black at brightness level b (bₘᵢₙ≦b≦bₘₐₓ). In one embodiment, for definiteness, let bₘᵢₙ=0 and bₘₐₓ=100.

The method 100 thus is initialized at step 102 and proceeds to step 104, where the method 100 computes a target or baseline JND value, j_{B}=j(Lₘᵢₙ)+x, where x is a predefined number of JNDs that L(0,b) should be above Lₘᵢₙ=L(0,bₘᵢₙ) in cd/m². That is, the target JND value is the estimated value of luminance at which further increase of the “brightness” setting will produce a noticeable difference in the black level of the home theater display. In one embodiment, x is empirically determined to be approximately 0.9. Although the remainder of the discussion of the method 100 assumes that x=0.9, it will be appreciated that this is an exemplary value only, and that other values for x may also be used without deviating from the spirit of the present invention.

In step 106, the method 100 prompts the user to measure the luminance of 0-digital-level black at the minimum and maximum “brightness” settings bₘᵢₙ and bₘₐₓ, respectively, and then computes the corresponding JND values j(L(0, bₘᵢₙ) and j(L(0, bₘₐₓ)) for each of the received luminance values. The idea in step 106 is to make as few measurements as possible; thus, in one embodiment, a maximum of two measurements (i.e., the minimum and maximum settings bₘᵢₙ and bₘₐₓ) is made.

In step 108, the method 100 sets bₘ=bₘᵢₙ and bₚ=bₘₐₓ. The method 100 then proceeds to step 109 and sets an intermediate “brightness” setting, bᵢₙₜ, where bᵢₙₜ=(bₘ+bₚ)/2 (i.e., such that bᵢₙₜ is approximately halfway between bₘ and bₚ. Thus, in the current example, bᵢₙₜ=50.

In step 110, the method 100 directs the user to set the “brightness” setting b=bᵢₙₜ and to measure L(0,b). The method 100 then proceeds to step 112 and determines whether j(L(0,b)) is within 0.45 JND (i.e., half of x JND) of the target JND value j_{B}. If the method 100 concludes in step 112 that j(L(0,b)) is within 0.45 JND of the target JND value j_{B}, the method 100 proceeds to step 114 and directs the user to adopt the current value of the “brightness” setting b before terminating in step 126.

Alternatively, if the method 100 concludes in step 112 that j(L(0,b)) is not within 0.45 JND of the target JND value j_{B}, the method 100 proceeds to step 116 and determines whether j(L(0,b))<j_{B}. If the method 100 concludes in step 116 that j(L(0,b))<j_{B}, the method 100 proceeds to step 118 and resets bₘ=bᵢₙₜ and Δb=bₚ−bᵢₙₜ. If, however, the method 100 concludes in step 116 that j(L(0,b))>j_{B}, the method 100 proceeds to step 120 and resets bₚ=bᵢₙₜ and Δb=bᵢₙₜ−bₘ.

Once bₘ or bₚ and Δb have been reset in accordance with either of steps 118 and 120, the method 100 proceeds to step 122 and determines whether Δb≦1. If the method 100 concludes in step 122 that Δb≦1, the method 100 proceeds to step 114 and directs the user to adopt the current value of the “brightness” setting b before terminating in step 126.

Alternatively, if the method 100 concludes in step 122 that Δb>1, the method 100 returns to step 109 and proceeds as described above to reset bᵢₙₜ using the current values for bₘ and bₚ.

In one embodiment, where the home theater display to be calibrated has a minimum-“brightness” setting bₘᵢₙ that produces a non-minimum luminance L(0,bₘᵢₙ), the method 100 is re-initialized whenever a new minimum luminance is measured.

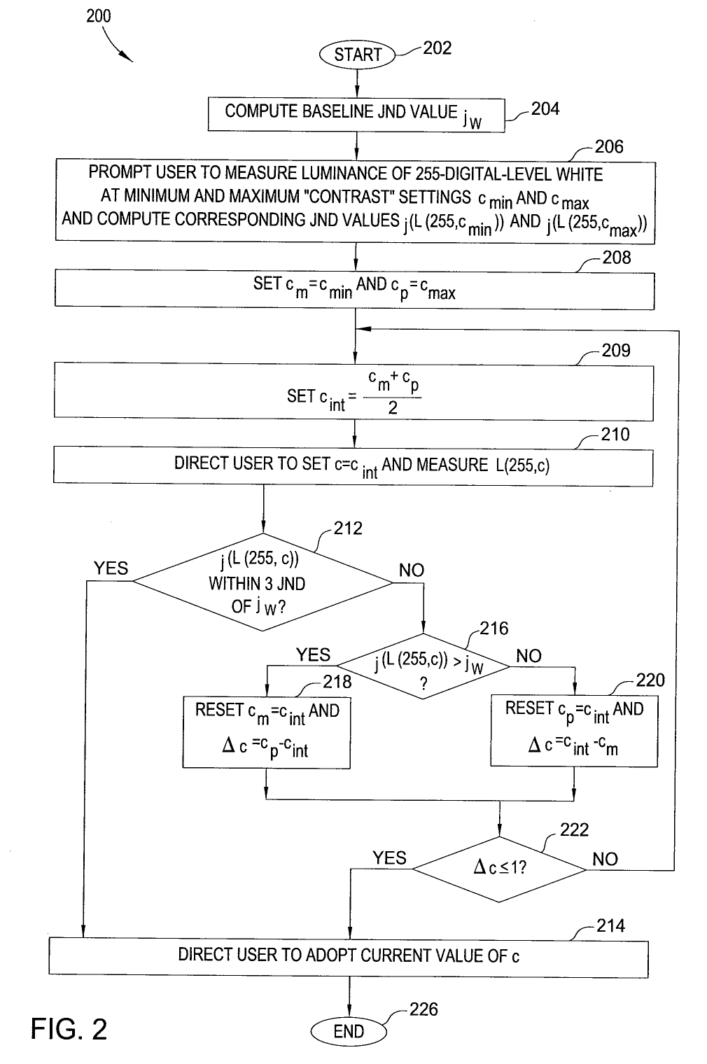

FIG. 2 is a flow diagram illustrating one embodiment of a method 200 for automatically directing the adjustment of the “contrast” (and white) setting of a home theater display, according to the present invention. The method 200 thus may be implemented, for example, in an automated, stand-alone display calibrator that operates in conjunction with a calorimeter to guide a user in the adjustment of the “contrast” setting. For the “contrast” setting c (and white), let L(255,c)=the luminance of 255-digital-level white at contrast level c (cₘᵢₙ≦c≦cₘₐₓ). In one embodiment, for definiteness, let cₘᵢₙ=0 and cₘₐₓ=100.

The method 200 thus is initialized at step 202 and proceeds to step 204, where the method 200 computes a target JND value, j_{W}=j(Lₘₐₓ)−y, where y is a predefined number of JNDs that L(255,c) should be below Lₘₐₓ=L(255,cₘₐₓ) in cd/m². That is, the target JND value is the estimated value of luminance at which further decrease of the “contrast” setting will produce a noticeable difference in the white level of the home theater display. In one embodiment, y is empirically determined to be approximately 6. Although the remainder of the discussion of the method 200 assumes that y=6, it will be appreciated that this is an exemplary value only, and that other values for y may also be used without deviating from the spirit of the present invention.

In step 206, the method 200 prompts the user to measure the luminance of maximum (e.g., 255)-digital-level white at the minimum and maximum “contrast” settings cₘᵢₙ and cₘₐₓ, respectively, and then computes the corresponding JND values j(L(0, cₘᵢₙ) and j(L(0, cₘₐₓ)) for each of the received luminance values. The idea in step 206 is to make as few measurements as possible; thus, in one embodiment, a maximum of two measurements (i.e., the minimum and maximum settings cₘᵢₙ and cₘₐₓ) is made.

In step 208, the method 200 sets cₘ=cₘᵢₙ and cₚ=cₘₐₓ. The method 200 then proceeds to step 209 and sets an intermediate “contrast” setting, cᵢₙₜ, where cᵢₙₜ=(cₘ+cₚ)/2 (i.e., such that cᵢₙₜ is approximately halfway between cₘ and cₚ. Thus, in the current example, cᵢₙₜ=50.

In step 210, the method 200 directs the user to set the “contrast” setting c=cᵢₙₜ and to measure L(255,c). The method 200 then proceeds to step 212 and determines whether j(L(255,c)) is within 3 JND (i.e., half of y JND) of the target JND value j_{W}. If the method 200 concludes in step 212 that j(L(255,c)) is within 3 JND of the target JND value j_{W}, the method 200 proceeds to step 214 and directs the user to adopt the current value of the “contrast” setting c before terminating in step 226.

Alternatively, if the method 200 concludes in step 212 that j(L(255,c)) is not within 3 JND of the target JND value j_{W}, the method 200 proceeds to step 216 and determines whether j(L(255,c))>j_{W}. If the method 200 concludes in step 216 that j(L(0,b))<j_{B}, the method 200 proceeds to step 218 and resets bₘ=bᵢₙₜ and Δb=bₚ−bᵢₙₜ. If, however, the method 200 concludes in step 216 that j(L(255,c))<j_{W}, the method 200 proceeds to step 220 and resets cₚ=cᵢₙₜ and ΔC=cᵢₙₜ−cₘ.

Once cₘ or cₚ and Δc have been reset in accordance with either of steps 218 and 220, the method 200 proceeds to step 222 and determines whether Δc≦1. If the method 200 concludes in step 222 that Δc≦1, the method 200 proceeds to step 214 and directs the user to adopt the current value of the “contrast” setting c before terminating in step 226.

Alternatively, if the method 200 concludes in step 222 that Δc>1, the method 200 returns to step 209 and proceeds as described above to reset cᵢₙₜ using the current values for cₘ and cₚ.

In one embodiment, where the home theater display to be calibrated has a maximum-“contrast” setting cₘₐₓ that produces a non-maximum luminance L(255,cₘₐₓ), the method 200 is re-initialized whenever a new maximum luminance is measured.

In one embodiment, the DICOM grayscale function (e.g., as described in “Digital Imaging and Communications in Medicine (DICOM) 4: Grayscale Standard Display Function”, National Electrical Manufacturers Association (NEMA) Standard PS 3.14-1999, which is herein incorporated by reference) is used to generate the target luminances j_{B} and j_{W} defined above for the black and white adjustments through brightness and contrast (i.e., as discussed with reference to FIGS. 1 and 2). The DICOM function expresses L[j], where L is in cd/m² and j is the number of JNDs from a particular black. The inverse of the DICOM function, j(L), is used.

The function (implemented in double precision) is given by:

j(L)=A+B·Log₁₀(L)+C·(Log₁₀(L))²+D·(Log₁₀(L))³+E·(Log₁₀(L))⁴+F·(Log₁₀(L))⁵+G·(Log₁₀(L))⁶+H·(Log₁₀(L))⁷+I·(Log₁₀(L))⁸ (EQN. 1)

where A=71.498068, B=94.593053, C=41.912053, D=9.8247004, E=0.28175407, F=−1.1878455, G=−0.18014349, H=0.14710899, I=−0.017046845.

For very low-luminance readings (e.g., less than 0.05 cd/m²), the DICOM JND-versus-luminance function j(L) is extrapolated following some known facts about human vision.

For example, in one embodiment, define L[1]=0.04999 and L[2]=0.05469, both in cd/m² (using these numbers avoids any evaluation of the L[j] function to which the j(L) function is an inverse). Further, define B=0.5 L[1]/(L[2]−L[1])−1 and A=L[1]/(1+B)^{0.5}. For L<0.0499, j(L)=(L/A)²−B. Here, A and B are chosen so that the value and slope of the extrapolated function match the main DICOM function at L=0.499, j=1.

This low-luminance square-root law j⁻¹(L) is like the DeVries-Rose law in vision science (see, e.g., G. Wyszecki and W. S. Stiles, Color Science, 2^{nd} ed. Wiley, 1982, p. 647, which is herein incorporated by reference). Two qualitative features render this choice empirically attractive: (1) the interval between 0.046 and 0.049 cd/m̂2 corresponds to 0.6 JND; and (2) the interval between 0.01 and 0.03 cd/m̂2 corresponds to 1.7 JND. This approximately agrees with observed values for setting plasma and cathode ray tube (CRT) home theater displays.

The methods of FIGS. 1 and 2 continue until either two adjacent measurements are within half the criterion JND interval away from white (for “contrast”, as in the case of FIG. 2) or black (for “brightness”, as in the case of FIG. 1), or until one measurement reaches the integer granularity of the b (“brightness”) or c (“contrast”) scale.

To allow more control on the stopping criterion for the method 100 or the method 200 (e.g., for future home theater displays) the methods 100 and 200 may be modified as follows. The method 100 or 200 will interpolate between existing measurements to retrieve the desired b “(brightness”, as in the case of the method 100) and c (“contrast”, as in the case of the method 200) values. The interpolation takes over, for example, in steps 118 and/or 120 of the method 100, or in steps 218 and/or 220 of the method 200.

In the case of the method 100 (i.e., “brightness” setting), step 118 assigns the new bᵢₙₜ=bᵢₙₜ′ and L(0, bᵢₙₜ′)=Lᵢₙₜ′, while step 120 assigns the new bᵢₙₜ=bᵢₙₜ″ and L(0, bᵢₙₜ″)=Lᵢₙₜ″. bᵢₙₜ is then computed as an interpolated value (rounded to the nearest integer): bᵢₙₜ=bᵢₙₜ″+(bᵢₙₜ″−bᵢₙₜ′)(L_{B}−Lᵢₙₜ′)/(Lᵢₙₜ″−Lᵢₙₜ′). Thus, the new bᵢₙₜ values calculated in steps 118 and 120 are interpolated. One embodiment of a method for calculating L_{B} is discussed in greater detail below.

In the case of the method 200 (i.e., “contrast” setting), step 218 assigns the new cᵢₙₜ=cᵢₙₜ′ and L(255, cᵢₙₜ′)=Lᵢₙₜ′, while step 220 assigns the new cᵢₙₜ=cᵢₙₜ″ and L(255, cᵢₙₜ″)=Lᵢₙₜ″. cᵢₙₜ is then computed as an interpolated value (rounded to nearest integer): cᵢₙₜ is then computed as =cᵢₙₜ′+(cᵢₙₜ″−cᵢₙₜ′)(L_{W}−cᵢₙₜ′)/(cᵢₙₜ″−cᵢₙₜ′). Thus, the new cᵢₙₜ values calculated in steps 218 and 220 are interpolated. One embodiment of a method for calculating L_{W} is discussed in greater detail below.

Before one can perform these interpolations, one must compute L_{B} from j_{B} and L_{W} from j_{W}. In one embodiment, this computation is performed by implementing (in double precision) the forward DICOM transformation L[j] from JND values to luminance (cd/m²):

$${Log}_{10} L ( j ) = \frac{a + c \cdot ln ( j ) + e \cdot {( ln ( j ) )}^{2} + g \cdot {( ln ( j ) )}^{3} + m \cdot {( ln ( j ) )}^{4}}{\begin{matrix}l + b \cdot ln ( j ) + d \cdot {( ln ( j ) )}^{2} + f \cdot \\ {( ln ( j ) )}^{3} + h \cdot {( ln ( j ) )}^{4} + k \cdot {( ln ( j ) )}^{5}\end{matrix}} \qquad ( EQN . 2 )$$

where ln and Log₁₀ are respectively the natural logarithm and the base-10 logarithm, j the JND index (1 of 1023) of the Luminance levels Lⱼ of the JNDs, and a=−1.3011877, b=−2.5840191E−2, c=8.0242636E−2, d=−1.0320229E−1, e=1.3646699E−1, f=2.8745620E−2, g=−2.5468404E−2, h=−3.1978977E−3, k=1.2992634E−4, m=1.3635334E−3. It is noted that in the case of EQN. 2, the variables b and c represent parameter values, and not “brightness” and “contrast” settings, as respectively used elsewhere herein.

On some home theater displays, a “contrast” slider changes the screen-white chromaticity. To deal with this change, one can forbid a “contrast” setting for which the screen chromaticity (u′, v′) deviates more than 0.01 from the screen white (uₒ′,vₒ′) attained at the center of the “contrast”-slider scale. The criterion is Δ(u′,v′)=0.01, where u′=4x/(−2x+12y+3), v′=9y/(−2x+12y+3), and Δ(u′v′)=[(u′−uₒ′)²+(v′−vₒ′)²]^{0.5} and x and y are CIE chromaticity coordinates, as derived from CIE 1931 XYZ values according to x=X/(X+Y+Z), y=Y/(X+Y+Z). Thus, (u′, v′) may be referred to as the CIE uniform-chromaticity coordinates, because relative to CIE chromaticity coordinates (x, y), (u′, v′) represents equal distances as closer to equal perceptual differences. If a “contrast” setting fails this test, the binary search explores no setting that is farther than the center value.

In further embodiments, the present invention provides a method and apparatus for automatically directing the adjustment of the “color” and “tint” settings of a home theater display. In one embodiment, directing the adjustment of the “color” and “tint” settings is facilitated by simulating the action of a blue-filtered luminance through a linear combination of the seven colorimeter channel outputs, each channel's spectral sensitivity being its filter transmittance multiplied by the detector sensitivity. In one embodiment, the linear combination is chosen to be a least-square best fit (over wavelength λ) to the CIE Y function times the spectral transmission of a Tokyo Blue filter, such as that commercially available from Lee Filters of Burbank, Calif. In the colorimeter's usual mode, Level-1 calibration finds the linear combinations of the seven filter-detector functions that least-square matches the X, Y, and Z color-matching functions. In accordance with the present invention, instead of CIE color-matching functions X(λ), Y(λ), or Z(λ), the function matched is Y(λ) T(λ), where T(λ) is the Tokyo-Blue filter transmittance.

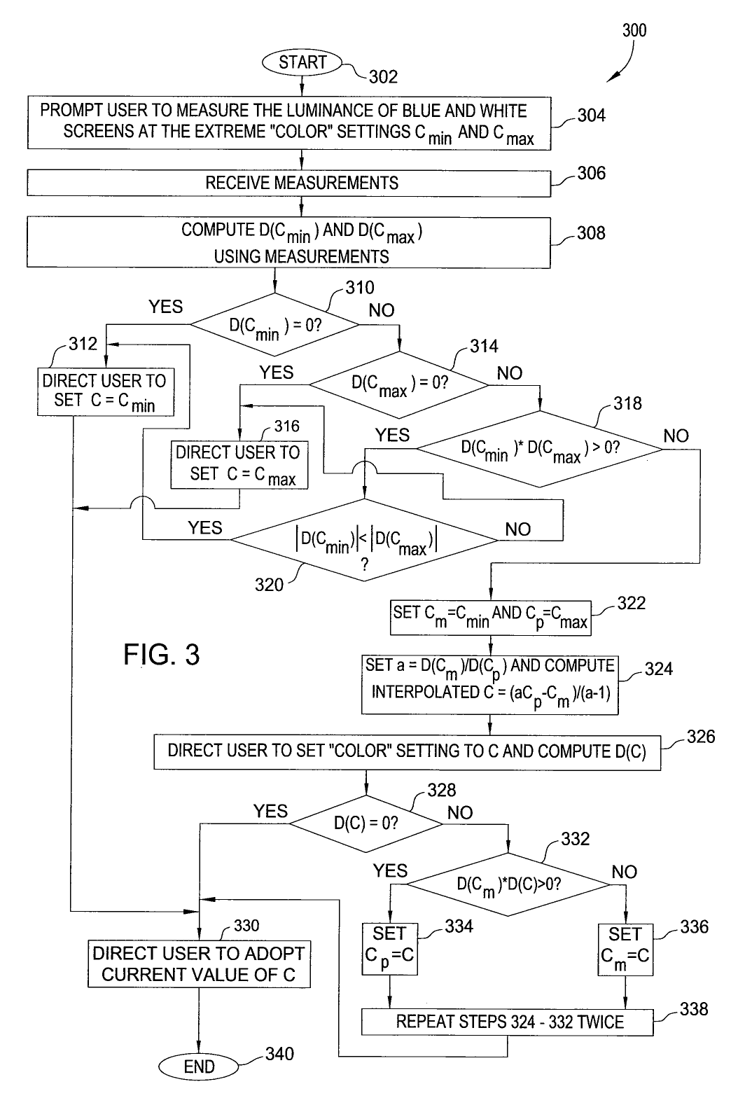

FIG. 3 is a flow diagram illustrating one embodiment of a method 300 for automatically directing the adjustment of the “color” setting of a home theater display, according to the present invention. The method 300 thus may be implemented, for example, in an automated, stand-alone display calibrator that operates in conjunction with a colorimeter to guide a user in the adjustment of the “color” setting.

For the purposes of the method 300, to calibrate the “color” and “tint” controls on a display, a colorimeter is used with n input filters. In one embodiment, n=7 filters with transmission spectra fᵢ(λ) overlay detectors with sensitivity d(λ). Prior to measuring any display, the calorimeter is calibrated to simulate luminance measurements through a Tokyo Blue filter. The calibration task is then to find the coefficients kᵢ that produce the least-square best fit of

$${\sum }_{i = 1}^{n} {k}_{i} {f}_{i} ( λ ) d ( λ ) to Y ( λ ) T ( λ ) , i . e . , to minimize \text{:} \\ {\sum }_{λ = {λ}_{min}}^{{λ}_{max}} {[ \{ {\sum }_{i = 1}^{n} {k}_{i} {f}_{i} ( λ ) d ( λ ) \} - Y ( λ ) T ( λ ) ]}^{2} \qquad ( EQN . 3 )$$

where “λₘᵢₙ” and “λₘₐₓ” are limiting nanometer values and signal the consideration of all visible wavelengths λ. In one embodiment, λₘᵢₙ=400 and λₘₐₓ=700.

Referring back to FIG. 3, suppose a colorimeter operates in the mode of Y-times-Tokyo-Blue calibration described above. In that mode, the present invention guides “color” and “tint” settings by prompting a user in each case to perform a binary search toward a setting for which the relevant test pattern's screen colors (e.g., blue vs. white or cyan vs. magenta) produce the same value as measured by the specially calibrated colorimeter.

For the purposes of the method 300, full-on blue display color is denoted as B, and full-on white display color is denoted as W. Either of these display colors is shown with a given “color” setting C. For any “color” setting C (from a minimum setting Cₘᵢₙ to a maximum setting Cₘₐₓ), the respective B- and W-screen measurements of simulated luminance through the simulated blue filter is denoted as L(C,B) and L(C,W). The goal, then, is to, while making a minimum number of measurements, find the “color” setting C for which the difference D(C) (where D(C)=L(C,B)−L(C,W)) is approximately zero. If such a setting C does not exist, the goal is to find the condition for which the absolute difference |D(C)| is minimized. It is unknown whether D(C) is increasing or decreasing in the setting C, but it is known that D(C) is monotonic (i.e., has no extrema).

Accordingly, for the “color” control, the method 300 is initialized at step 302 and proceeds to step 304, where the method 300 prompts the user to measure the luminance of the blue and white screens at the extreme “color” settings (i.e., Cₘᵢₙ and Cₘₐₓ). Thus, the user measures L(Cₘᵢₙ, W), L(Cₘᵢₙ, B), L(Cₘₐₓ, W) and L(Cₘₐₓ, B).

In step 306, the method 300 receives the requested measurements from the user. The method 300 then proceeds to step 308 and computes the differences D(Cₘᵢₙ)=L(Cₘᵢₙ,B)−L(Cₘᵢₙ,W) and D(Cₘₐₓ)=L(Cₘₐₓ,B)−L(Cₘₐₓ,W), for each of the extreme “color” settings.

In step 310, the method 300 determines whether D(Cₘᵢₙ) is approximately equal to zero. If the method 300 concludes in step 310 that D(Cₘᵢₙ) is approximately equal to zero, the method 300 proceeds to step 312 and directs the user to set the “color” setting C to Cₘᵢₙ. The method 300 directs the user to adopt the current value of C (i.e., Cₘᵢₙ) for the “color” setting in step 330 before terminating in step 340.

Alternatively, if the method 300 concludes in step 310 that D(Cₘᵢₙ) is not approximately equal to zero, the method 300 proceeds to step 314 and determines whether D(Cₘₐₓ) is approximately equal to zero. If the method 300 concludes in step 314 that D(Cₘₐₓ) is approximately equal to zero, the method 300 proceeds to step 316 and directs the user to set the “color” setting C to Cₘₐₓ. The method 300 directs the user to adopt the current value of C (i.e., Cₘₐₓ) for the “color” setting in step 330 before terminating in step 340.

Alternatively, if the method 300 concludes in step 314 that D(Cₘₐₓ) is not approximately equal to zero, the method 300 proceeds to step 318 and determines whether the product D(Cₘᵢₙ)*D(Cₘₐₓ) is greater than zero. If the method 300 concludes in step 318 that D(Cₘᵢₙ)*D(Cₘₐₓ) is greater than zero, the method 300 proceeds to step 320 and determines whether |D(Cₘᵢₙ)| is less than |D(Cₘₐₓ)|. If the method 300 concludes in step 320 that |D(Cₘᵢₙ)| is less than |D(Cₘₐₓ)|, the method 300 advances to step 312 and directs the user to set the “color” setting C to Cₘᵢₙ before proceeding as described above.

Alternatively, if the method 300 concludes in step 320 that |D(Cₘᵢₙ)| is not less than |D(Cₘₐₓ)|, the method 300 advances to step 316 and directs the user to set the “color” setting C to Cₘₐₓ before proceeding as described above.

Referring back to step 318, if the method 300 concludes that D(Cₘᵢₙ)* D(Cₘₐₓ) is not greater than zero, the method 300 proceeds to step 322 and sets Cₘ=Cₘᵢₙ and Cₚ=Cₘₐₓ. In step 324, the method 300 estimates the “color” setting C for equality. In one embodiment, the “color” setting C is estimated using iterated interpolation as:

C=(aCₚ−Cₘ)/(a−1) (EQN. 4)

where a=D(Cₘ)/D(Cₚ) (EQN. 5)

In step 326, the method 300 directs the user to set the “color” setting to C and computes D(C). The method 300 then proceeds to step 328 and determines whether D(C) is approximately equal to zero. If the method 300 concludes in step 328 that D(C) is approximately equal to zero, the method 300 proceeds to step 330 and directs the user to adopt the current value of C (i.e., interpolated C) as the “color” setting, as described above.

Alternatively, if the If the method 300 concludes in step 328 that D(C) is not approximately equal to zero, the method 300 proceeds to step 332 and determines whether D(Cₘ)*D(C) is greater than zero. If the method 300 concludes in step 332 that D(Cₘ)*D(C) is greater than zero, the method 300 proceeds to step 334 and sets Cₚ=C. Alternatively, if the method 300 concludes in step 332 that D(Cₘ)*D(C) is not greater than zero, the method 300 proceeds to step 336 and sets Cₘ=C.

Once C has been set to either Cₚ or Cₘ (i.e., in accordance with step 334 or step 336), the method 300 proceeds to step 338 and repeats steps 324-336 twice before directing the user to adopt the current value of C as the “color” setting, as described above.

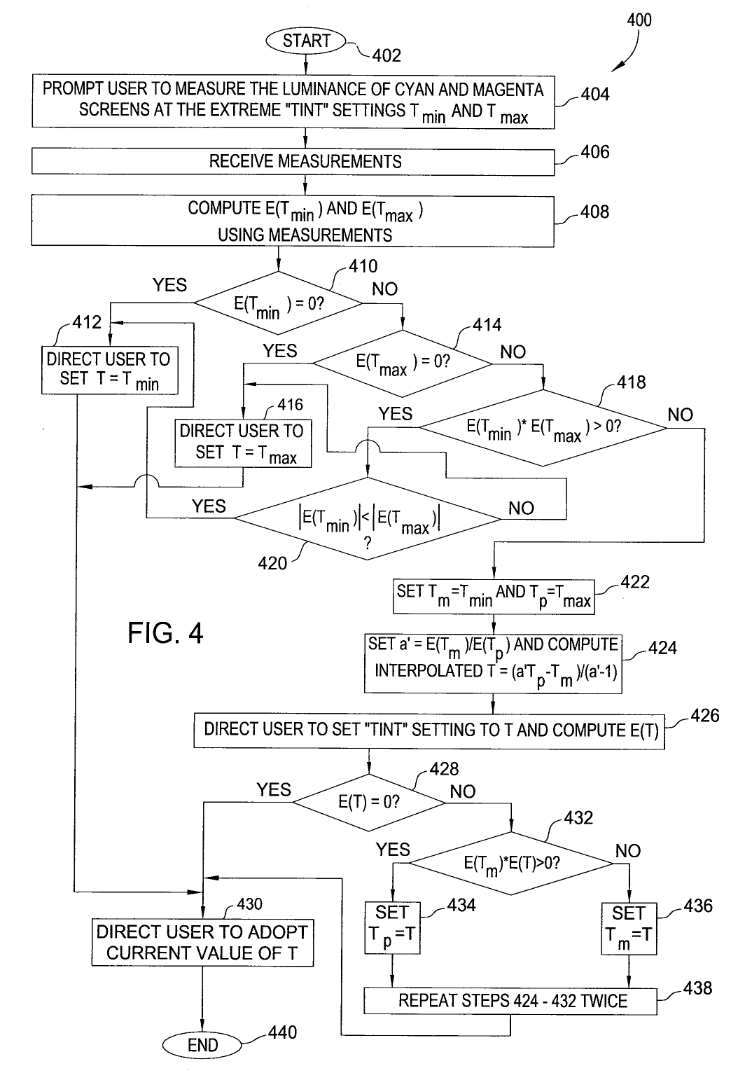

FIG. 4 is a flow diagram illustrating one embodiment of a method 400 for automatically directing the adjustment of the “tint” setting of a home theater display, according to the present invention. The method 400 thus may be implemented, for example, in an automated, stand-alone display calibrator that operates in conjunction with a calorimeter to guide a user in the adjustment of the “tint” setting. The method 400 operates in a manner analogous to the method 300, using the cyan and magenta screens.

For the purposes of the method 400, full-on cyan display color is denoted as Cy, and full-on magenta display color is denoted as M. Either of these display colors is shown with a given “tint” setting T. For any “tint” setting T (from a minimum setting Tₘᵢₙ to a maximum setting Tₘₐₓ), the respective Cy- and M-screen measurements of simulated luminance through the simulated blue filter is denoted as L(T,Cy) and L(T,M). The goal, then, is to, while making a minimum number of measurements, find the “tint” setting T for which the difference E(T) (where E(T)=L(T,Cy)−L(T,M)) is approximately zero. If such a setting T does not exist, the goal is to find the condition for which the absolute difference |E(T)| is minimized. It is unknown whether E(T) is increasing or decreasing in the setting T, but it is known that E(T) is monotonic (i.e., has no extrema).

Accordingly, for the “tint” control, the method 400 is initialized at step 402 and proceeds to step 404, where the method 400 prompts the user to measure the luminance of the cyan and magenta screens at the extreme “tint” settings (i.e., Tₘᵢₙ and Tₘₐₓ). Thus, the user measures L(Tₘᵢₙ, Cy), L(Tₘᵢₙ, M), L(Tₘₐₓ, Cy) and L(Tₘₐₓ, M).

In step 406, the method 400 receives the requested measurements from the user. The method 400 then proceeds to step 408 and computes the differences E(Tₘᵢₙ)=L(Tₘᵢₙ,M)−L(Tₘᵢₙ,Cy) and E(Tₘₐₓ)=L(Tₘₐₓ,M)−L(Tₘₐₓ,Cy), for each of the extreme “tint” settings.

In step 410, the method 400 determines whether E(Tₘᵢₙ) is approximately equal to zero. If the method 400 concludes in step 410 that E(Tₘᵢₙ) is approximately equal to zero, the method 400 proceeds to step 412 and directs the user to set the “tint” setting T to Tₘᵢₙ. The method 400 directs the user to adopt the current value of T (i.e., Tₘᵢₙ) for the “tint” setting in step 430 before terminating in step 440.

Alternatively, if the method 400 concludes in step 410 that E(Tₘᵢₙ) is not approximately equal to zero, the method 400 proceeds to step 414 and determines whether E(Tₘₐₓ) is approximately equal to zero. If the method 400 concludes in step 414 that E(Tₘₐₓ) is approximately equal to zero, the method 400 proceeds to step 416 and directs the user to set the “tint” setting T to Tₘₐₓ. The method 400 directs the user to adopt the current value of T (i.e., Tₘₐₓ) for the “tint” setting in step 430 before terminating in step 440.

Alternatively, if the method 400 concludes in step 414 that E(Tₘₐₓ) is not approximately equal to zero, the method 400 proceeds to step 418 and determines whether the product E(Tₘᵢₙ)*E(Tₘₐₓ) is greater than zero. If the method 400 concludes in step 418 that D(Cₘᵢₙ)*D(Cₘₐₓ) is greater than zero, the method 400 proceeds to step 420 and determines whether |E(Tₘᵢₙ) | is less than |E(Tₘₐₓ) |. If the method 400 concludes in step 420 that |E(Tₘᵢₙ) | is less than |D(Tₘₐₓ) |, the method 400 proceeds to step 412 and directs the user to set the “tint” setting T to Tₘᵢₙ before proceeding as described above.

Alternatively, if the method 400 concludes in step 420 that |E(Tₘᵢₙ) | is not less than |E(Tₘₐₓ) |, the method 400 proceeds to step 416 and directs the user to set the “tint” setting T to Tₘₐₓ before proceeding as described above.

Referring back to step 418, if the method 400 concludes that E(Tₘᵢₙ)* E(Tₘₐₓ) is not greater than zero, the method 400 proceeds to step 422 and sets Tₘ=Tₘᵢₙ and Tₚ=Tₘₐₓ. In step 424, the method 400 estimates the “tint” setting T for equality. In one embodiment, the “tint” setting T is estimated using iterated interpolation as:

T=(a′Tₚ−Tₘ)/(a′−1) (EQN. 6)

where a′=E(Tₘ)/E(Tₚ) (EQN. 7)

In step 426, the method 400 directs the user to set the “tint” setting to T and computes E(T). The method 400 then proceeds to step 428 and determines whether E(T) is approximately equal to zero. If the method 400 concludes in step 428 that E(T) is approximately equal to zero, the method 400 proceeds to step 430 and directs the user to adopt the current value of T (i.e., interpolated T) as the “tint” setting, as described above.

Alternatively, if the If the method 400 concludes in step 428 that E(T) is not approximately equal to zero, the method 400 proceeds to step 432 and determines whether E(Tₘ)*E(T) is greater than zero. If the method 400 concludes in step 432 that E(Tₘ)*E(T) is greater than zero, the method 400 proceeds to step 434 and sets Tₚ=T. Alternatively, if the method 400 concludes in step 432 that E(Tₘ)*E(T) is not greater than zero, the method 400 proceeds to step 436 and sets Tₘ=T.

Once T has been set to either Tₚ or Tₘ(i.e., in accordance with step 434 or step 436), the method 400 proceeds to step 438 and repeats steps 424-436 twice before directing the user to adopt the current value of T as the “tint” setting, as described above.

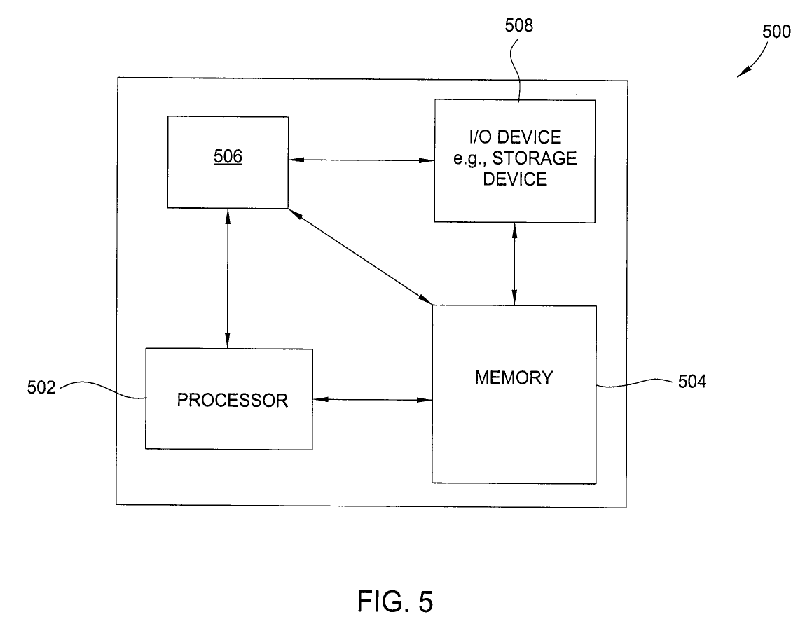

FIG. 5 is a high level block diagram of the home theater display adjustment method that is implemented using a general-purpose computing device 500. In one embodiment, a general-purpose computing device 500 comprises a processor 502, a memory 504, an adjustment module 505 and various input/output (I/O) devices 506 such as a display, a keyboard, a mouse, a modem, and the like. In one embodiment, at least one I/O device is a storage device (e.g., a disk drive, an optical disk drive, a floppy disk drive). It should be understood that the adjustment module 505 can be implemented as a physical device or subsystem that is coupled to a processor through a communication channel.

Alternatively, the adjustment module 505 can be represented by one or more software applications (or even a combination of software and hardware, e.g., using Application Specific Integrated Circuits (ASIC)), where the software is loaded from a storage medium (e.g., I/O devices 506) and operated by the processor 502 in the memory 504 of the general-purpose computing device 500. Thus, in one embodiment, the adjustment module 505 for adjusting the settings of a home theater display described herein with reference to the preceding Figures can be stored on a computer readable medium or carrier (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for adjusting a setting of a home theater display, the method comprising:
receiving at least one measurement of the setting from a user;
directing the user to adjust the setting in response to the received at least one measurement.

2. The method of claim 1, wherein the at least one measurement comprises measurements of a luminance of the display at a plurality of levels of the setting including at least extreme levels of the setting, where the extreme levels comprise a minimum level of the setting and a maximum level of the setting.

3. The method of claim 2, wherein a degree of the adjustment is determined in accordance with a perceptual scale.

4. The method of claim 3, wherein the perceptual scale is luminance linearized in units of just-noticeable differences.

5. The method of claim 4, wherein the directing comprises:
identifying one of the plurality of levels of the setting at which the luminance of the display is a predefined number of just noticeable differences from the luminance at an extreme level of the setting; and
directing the user to adjust the setting to the identified one of the plurality of levels.

6. The method of claim 5, wherein the setting is “brightness”.

7. The method of claim 6, wherein the predefined number of just noticeable differences is approximately 0.9 greater than the luminance at the minimum level of the setting, for black luminance.

8. The method of claim 6, wherein the method is re-initialized whenever a new minimum luminance is measured for a home theater display in which the minimum level of the setting produces a non-minimum luminance.

9. The method of claim 5, wherein the setting is “contrast”.

10. The method of claim 9, wherein the predefined number of just noticeable differences is approximately 6 less than the luminance at the maximum level of the setting, for white luminance.

11. The method of claim 9, wherein the method is re-initialized whenever a new maximum luminance is measured for a home theater display in which the maximum level of the setting produces a non-maximum luminance.

12. The method of claim 5, wherein the identifying comprises:
computing a target just noticeable difference value, in accordance with the predefined number and the luminance at the extreme level of the setting;
computing a just noticeable difference value for luminance at an intermediate level of the setting, the intermediate level initially occurring approximately halfway between the minimum level and the maximum level; and
directing the user to adjust the intermediate level of the setting until the just noticeable difference value for luminance at the intermediate level of the setting is within half of the predefined number of just noticeable differences from the target just noticeable difference value.

13. The method of claim 12, wherein directing the user to adjust the intermediate level of the setting comprises:
halving a distance between the intermediate level and the maximum level to produce a new intermediate level, if the target just noticeable difference value is greater than the just noticeable difference value for the luminance at the intermediate level of the setting; and
halving a distance between the minimum level and the intermediate level to produce a new intermediate level, if the target just noticeable difference value is less than the just noticeable difference value for the luminance at the intermediate level of the setting.

14. The method of claim 13, wherein the halving is repeated until a new intermediate level is produced at which the just noticeable difference value for luminance is within half of the predefined number of just noticeable differences from the target just noticeable difference value.

15. The method of claim 4, wherein the perceptual scale is luminance in any scale, and where a spectral sensitivity is simulated in a multi-filter colorimeter to approximate the International Commission on Illumination luminance spectral sensitivity times transmittance of a blue filter.

16. The method of claim 15, wherein the setting is “color”.

17. The method of claim 16, wherein the measurements of the luminance of the display at the plurality of levels are made for both a full-on white display and a full-on blue display.

18. The method of claim 17, wherein the directing comprises:
identifying a level of the setting at which a difference between the luminance of the full-on white display and the luminance of the full-on blue display is approximately zero; and
directing the user to adjust the setting to the identified level.

19. The method of claim 17, wherein the directing comprises:
identifying a level of the setting at which an absolute difference between the luminance of the full-on white display and the luminance of the full-on blue display is minimized; and
directing the user to adjust the setting to the identified level.

20. The method of claim 15, wherein the setting is “tint”.

21. The method of claim 20, wherein the measurements of the luminance of the display at the plurality of levels are made for both a full-on cyan display and a full-on magenta display.

22. The method of claim 21, wherein the directing comprises:
identifying a level of the setting at which a difference between the luminance of the full-on cyan display and the luminance of the full-on magenta display is approximately zero; and
directing the user to adjust the setting to the identified level.

23. The method of claim 21, wherein the directing comprises:
identifying a level of the setting at which an absolute difference between the luminance of the full-on cyan display and the luminance of the full-on magenta display is minimized; and
directing the user to adjust the setting to the identified level.

24. A computer readable medium containing an executable program for adjusting a setting of a home theater display, where the program performs the steps of:
receiving at least one measurement of the setting from a user;
directing the user to adjust the setting in response to the received at least one measurement.

25. The computer readable medium of claim 24, wherein the at least one measurement comprises measurements of a luminance of the display at a plurality of levels of the setting including at least extreme levels of the setting, where the extreme levels comprise a minimum level of the setting and a maximum level of the setting.

26. The computer readable medium of claim 25, wherein a degree of the adjustment is determined in accordance with a perceptual scale.

27. The computer readable medium of claim 26, wherein the perceptual scale is luminance linearized in units of just-noticeable differences.

28. The computer readable medium of claim 27, wherein the directing comprises:
identifying one of the plurality of levels of the setting at which the luminance of the display is a predefined number of just noticeable differences from the luminance at an extreme level of the setting; and
directing the user to adjust the setting to the identified one of the plurality of levels.

29. The computer readable medium of claim 28, wherein the setting is “brightness”.

30. The computer readable medium of claim 29, wherein the predefined number of just noticeable differences is approximately 0.9 greater than the luminance at the minimum level of the setting, for black luminance.

31. The computer readable medium of claim 29, wherein the method is re-initialized whenever a new minimum luminance is measured for a home theater display in which the minimum level of the setting produces a non-minimum luminance.

32. The computer readable medium of claim 28, wherein the setting is “contrast”.

33. The computer readable medium of claim 32, wherein the predefined number of just noticeable differences is approximately 6 less than the luminance at the maximum level of the setting, for white luminance.

34. The computer readable medium of claim 32, wherein the method is re-initialized whenever a new maximum luminance is measured for a home theater display in which the maximum level of the setting produces a non-maximum luminance.

35. The computer readable medium of claim 28, wherein the identifying comprises:
computing a target just noticeable difference value, in accordance with the predefined number and the luminance at the extreme level of the setting;
computing a just noticeable difference value for luminance at an intermediate level of the setting, the intermediate level initially occurring approximately halfway between the minimum level and the maximum level; and
directing the user to adjust the intermediate level of the setting until the just noticeable difference value for luminance at the intermediate level of the setting is within half of the predefined number of just noticeable differences from the target just noticeable difference value.

36. The computer readable medium of claim 35, wherein directing the user to adjust the intermediate level of the setting comprises:
halving a distance between the intermediate level and the maximum level to produce a new intermediate level, if the target just noticeable difference value is greater than the just noticeable difference value for the luminance at the intermediate level of the setting; and
halving a distance between the minimum level and the intermediate level to produce a new intermediate level, if the target just noticeable difference value is less than the just noticeable difference value for the luminance at the intermediate level of the setting.

37. The computer readable medium of claim 36, wherein the halving is repeated until a new intermediate level is produced at which the just noticeable difference value for luminance is within half of the predefined number of just noticeable differences from the target just noticeable difference value.

38. The computer readable medium of claim 27, wherein the perceptual scale is luminance in any scale, and where a spectral sensitivity is simulated in a multi-filter colorimeter to approximate the International Commission on Illumination luminance spectral sensitivity times transmittance of a blue filter.

39. The computer readable medium of claim 38, wherein the setting is “color”.

40. The computer readable medium of claim 39, wherein the measurements of the luminance of the display at the plurality of levels are made for both a full-on white display and a full-on blue display.

41. The computer readable medium of claim 40, wherein the directing comprises:
identifying a level of the setting at which a difference between the luminance of the full-on white display and the luminance of the full-on blue display is approximately zero; and
directing the user to adjust the setting to the identified level.

42. The computer readable medium of claim 40, wherein the directing comprises:
identifying a level of the setting at which an absolute difference between the luminance of the full-on white display and the luminance of the full-on blue display is minimized; and
directing the user to adjust the setting to the identified level.

43. The computer readable medium of claim 38, wherein the setting is “tint”.

44. The computer readable medium of claim 43, wherein the measurements of the luminance of the display at the plurality of levels are made for both a full-on cyan display and a full-on magenta display.

45. The computer readable medium of claim 44, wherein the directing comprises:
identifying a level of the setting at which a difference between the luminance of the full-on cyan display and the luminance of the full-on magenta display is approximately zero; and
directing the user to adjust the setting to the identified level.

46. The computer readable medium of claim 44, wherein the directing comprises:
identifying a level of the setting at which an absolute difference between the luminance of the full-on cyan display and the luminance of the full-on magenta display is minimized; and
directing the user to adjust the setting to the identified level.

47. A system for adjusting a setting of a home theater display, the method comprising:
means for receiving at least one measurement of the setting from a user; and
means for directing the user to adjust the setting in response to the received at least one measurement.
